(19) United States
(12) Patent Application Publication
(10) Pub. No.: US 2025/0044266 A1
(43) Pub. Date: Feb. 6, 2025

(54) METHOD FOR QUANTITATIVELY DETECTING HYDROQUINONE

(71) Applicant: ANHUI UNIVERSITY, Hefei City (CN)

(72) Inventors: Gang HU, Hefei City (CN); Xiaofeng WANG, Hefei City (CN); Lixue WU, Hefei City (CN); Jun WANG, Hefei City (CN)

(73) Assignee: ANHUI UNIVERSITY, Hefei City (CN)

(21) Appl. No.: 18/441,009

(22) Filed: Feb. 14, 2024

(30) Foreign Application Priority Data
Jul. 31, 2023 (CN) 202310945671.4

(51) Int. Cl. G01N 31/22

(52) U.S. Cl. CPC G01N 31/229

(57) ABSTRACT

A method for quantitatively detecting hydroquinone including: using a “NaClO₂—C₄H₁₃NO—Na₂S₄O₆” CAT clock reaction system as a detection solution, wherein C₄H₁₃NO is tetramethylammonium hydroxide; recording a graph showing that a pH value in the CAT clock reaction system changes with time; obtaining the fact that the CAT clock reaction systems show different induction times to added solutions of hydroquinone with different concentrations; establishing a working curve based on a relationship between the concentrations of hydroquinone in the CAT clock reaction system and the induction times, thereby achieving a quantitative detection of the hydroquinone in a test sample.

### CROSS REFERENCE TO RELATED APPLICATION

This application claims priority to Chinese Patent Application No. 202310945671.4 filed on Jul. 31, 2023, the disclosure of which is incorporated herein by reference in its entirety.

### TECHNICAL FIELD

The present disclosure relates to an analysis and detection method, specifically to a method for quantitatively detecting hydroquinone by using a “NaClO₂—C₄H₁₃NO (tetramethylammonium hydroxide)-Na₂S₄O₆” clock reaction system, namely a chlorite-ammonium-tetrathionate clock reaction system (hereinafter referred to as CAT clock reaction system). The method for quantitatively analyzing hydroquinone is based on the different responses (i.e., different induction times) of the CAT clock reaction system to hydroquinone with different concentrations. The present disclosure belongs to the field of analytical chemistry.

### BACKGROUND

Hydroquinone, also known as 1,4-benzenediol, has a structure shown in Formula (I), which is a white needle crystal and is easily soluble in hot water, ethanol, and ether, and slightly soluble in benzene. Hydroquinone is also an important chemical raw material, and has shown a growing demand in recent years, with the consumer field expanding annually. The 1,4-benzenediol is widely used as an important raw material, an intermediate, and an auxiliary agent for medicines, pesticides, dyes, and rubber. This compound is mainly used in developers, anthraquinone dyes, azo dyes, rubber antioxidants and monomer polymerization inhibitors, food stabilizers and paint antioxidants, petroleum anticoagulants, ammonia synthesis catalysts and the like. The application fields of hydroquinone are gradually expanding. In addition to the use in traditional fields, the hydroquinone has also seen new developments in the fields such as chemical fertilizers, water treatment, and liquid crystal polymers. Moreover, hydroquinone could also be processed into other fine chemicals, such as 1,4-diaminoleucosomes and quinizarin. The hydroquinone is an intermediate of the herbicides quizalofop, fluazifop-butyl, fenthiaprop-ethyl, fenoxaprop-ethyl, haloxyfop-methyl, and lactofen, and is also an intermediate for medicines and dyes.

Hydroquinone is mainly determined by instrumental analysis, such as high-performance liquid chromatography (HPLC) and high-performance liquid chromatography-ultraviolet detection (HPLC-UV). There are also other determination methods for the hydroquinone, which involve iodometry, photometry, fluorescence detection and chemiluminescence. Chromatography has a high sensitivity and a desirable accuracy, but shows a reduced analytical sensitivity for samples with complex matrices. Therefore, it is extremely necessary to find a simple and rapid analytical method with desirable detection efficiency.

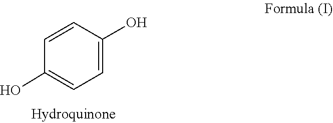

### SUMMARY

The present disclosure aims to provide a new method for quantitatively detecting hydroquinone, that is, a method for quantitative detection of hydroquinone by using a “NaClO₂—C₄H₁₃NO—Na₂S₄O₆” CAT clock reaction system as a detection solution. This method is a standard curve (working curve) method, which is based on a sensitive response of the CAT clock reaction system to the hydroquinone. Specifically, the method includes using a “NaClO₂—C₄H₁₃NO—Na₂S₄O₆” CAT clock reaction system as a detection solution, and forming graphs showing that pH changes with time; separately adding equal volumes of hydroquinone solutions with a series of different concentrations into the CAT clock reaction system when the CAT clock reaction starts; and quantitatively detecting hydroquinone according to the fact that the CAT clock reaction systems show different induction times to hydroquinone solutions with different concentrations added thereto.

In some embodiments, the method further includes establishing a working curve based on a relationship between the concentrations of hydroquinone in the CAT clock reaction system and the induction times, where an abscissa in the working curve represents the concentrations of hydroquinone in the CAT clock reaction system, and an ordinate in the working curve represents the induction times (t); when the concentration of hydroquinone in the CAT clock reaction system is a range of 4.44×10⁻⁸ mol/L to 1.33×10⁻⁷ mol/L, there is a linear relationship between the induction times t and the concentrations of hydroquinone in the CAT clock reaction system, thereby achieving the quantitative detection of the hydroquinone in a test sample.

The method according to the present disclosure differs from the prior art in that, the “NaClO₂—C₄H₁₃NO—Na₂S₄O₆” CAT clock reaction system is used as a detection solution and the CAT clock reaction system shows different response (i.e., induction times are different) to hydroquinone with different concentrations. Based on the above, the quantitative analysis of hydroquinone could be achieved.

In some embodiments, a detectable concentration of hydroquinone in the detection solution (CAT clock reaction system) is in a range of 4.44×10⁻⁸ mol/L to 1.33×10⁻⁷ mol/L.

In some embodiments, when detecting the hydroquinone in the detection solution (CAT clock reaction system), the CAT clock reaction system was controlled at a temperature of 23° C.±0.5° C.

In some embodiments, the range of the detectable concentration of the hydroquinone in the CAT clock reaction system is a preferred concentration range determined through experiments. Within the range of the detectable concentration, the induction time responds well to changes in hydroquinone concentration, with a high linear correlation coefficient. In addition, the concentrations of each component in the detection solution (CAT clock reaction system) are shown in Table 1; and the preferred concentrations of each component in the detection solution (CAT clock reaction system) obtained after multiple experiments are shown in Table 2.

TABLE 1
Concentrations of each component in CAT clock reaction system

| NaClO₂ | C₄H₁₃NO (mol/L) | Na₂S₄O₆ |
|---|---|---|
| (mol/L) | (tetramethylammonium hydroxide) | (mol/L) |
| 0.01-0.02 | 0.00021-0.0004 | 0.0012-0.0019 |

TABLE 2
Preferred concentrations of each
component in CAT clock reaction system

| NaClO₂ | C₄H₁₃NO (mol/L) | Na₂S₄O₆ |
|---|---|---|
| (mol/L) | (tetramethylammonium hydroxide) | (mol/L) |
| 0.01067 | 0.0003889 | 0.001556 |

A method for quantitatively detecting hydroquinone includes:

### 1. Preparation of a Detection Solution (CAT Clock Reaction System)

A detection solution (CAT clock reaction system) is prepared according to the concentration specified in Table 1, where a detection solution has a temperature of 23° C.±0.5° C.; a prepared working electrode (pH composite electrode, Lei-Ci, E-331) is inserted into the detection solution, and the electrode is connected to a computer through a potential/temperature/pH comprehensive tester (Jiaxing Disheng Electronic Technology Co., Ltd., China, ZHFX-595); acquisition time and sampling speed are set through a Chemical Signal Acquisition and Analysis program (Jiaxing Disheng Electronic Technology Co., Ltd., China) in the computer; after that, a START button is quickly pressed to monitor pH values in the corresponding solution (detection solution) every 0.5 second; a curve of the collected pH values in CAT clock reaction system changing with time is reported by the computer. When an analyte needs to be detected, the analyte is quickly added into the CAT clock reaction system when the CAT clock reaction starts, and a graph showing that pH in the CAT clock reaction system changes with time is recorded in the same way as described above.

In some embodiments, the detection solution (CAT clock reaction system) consists of components recited in Table 1, and NaClO₂ solution, C₄H₁₃NO solution, and Na₂S₄O₆ solution are separately prepared with distilled water as a solvent.

In some embodiments, the detection solution (CAT clock reaction system) consists of components recited in Table 2, and NaClO₂ solution, C₄H₁₃NO solution, and Na₂S₄O₆ solution were separately prepared with distilled water as a solvent.

In some embodiments, the detection solution (CAT clock reaction system) consists of NaClO₂, C₄H₁₃NO, Na₂S₄O₆ and distilled water.

The graph showing that a pH value in the CAT clock reaction system changes with time includes:
induction time: a duration from the start of the CAT clock reaction to the final stabilization of pH value; and
pH jump range: a pH value corresponding to the start of the pH jump to a pH value corresponding to the end of the pH jump in the CAT clock reaction system.

### 2. Establishment of a Working Curve Based on a Relationship Between a Concentration of the Hydroquinone in the Detection Solution and an Induction Time of the CAT Clock System

Standard hydroquinone solutions with a series of low concentrations are prepared by using distilled water as a solvent. Upon the CAT clock reaction starts, 20 μL of the standard hydroquinone solutions with a series of different concentrations are each added into each of the CAT clock reaction systems (each is 45 mL) by a pipette, respectively, such that a concentration of the hydroquinone in the system is in a range of 4.44×10⁻⁸ mol/L to 1.33×10⁻⁷ mol/L; a response of the CAT clock reaction system is the changes in an induction time, recorded as t; when the concentration of the hydroquinone in the system is different, the induction time (t) of the CAT clock reaction system is also different; a curve is plotted taking the concentration of the hydroquinone in the system as an abscissa and the induction time (t) as an ordinate, and such curve shows that when the concentration of hydroquinone in the system is in a range of 4.44×10⁻⁸ mol/L to 1.33×10⁻⁷ mol/L, there is a linear relationship between the induction time (t) and the concentration of the hydroquinone in the system.

### 3. Quantitative Detection of Hydroquinone

A test sample with an unknown concentration is added to the detection solution (CAT clock reaction system) when the CAT clock reaction starts, and the induction time (t) of a corresponding system can be measured. Based on the working curve, the concentration of hydroquinone in the detection system can be obtained according to the corresponding relationship between t and concentration of the hydroquinone in the detection system, and then the original concentration of hydroquinone in the test sample can be calculated.

### BRIEF DESCRIPTION OF THE DRAWINGS

FIG. 1 is a graph showing that a pH value in the detection solution (CAT clock reaction system) changes with time when no sample is added into the detection solution in Example 1.

FIG. 2 is a graph showing that a pH value in the detection solution (CAT clock reaction system) changes with time after addition of hydroquinone to make hydroquinone have concentration of 1.33×10⁻⁷ mol/L in the detection solution in Example 1.

FIG. 3 is a graph showing that a pH value in the detection solution (CAT clock reaction system) changes with time after addition of hydroquinone to make hydroquinone have concentration of 1.11×10⁻⁷ mol/L in the detection solution in Example 1.

FIG. 4 is a working curve showing the induction time t of the clock system as a function of the concentration of hydroquinone in Example 1.

FIG. 5 is a graph showing that a pH value in the detection solution (CAT clock reaction system) changes with time when no sample is added into the detection solution in Example 2.

FIG. 6 is a graph showing that a pH value in the detection solution (CAT clock reaction system) changes with time after addition of hydroquinone to make hydroquinone have concentration of 8.89×10⁻⁸ mol/L in the detection solution in Example 2.

FIG. 7 is a graph showing that a pH value in the detection solution (CAT clock reaction system) changes with time after addition of hydroquinone to make hydroquinone have concentration of 6.67×10⁻⁸ mol/L in the detection solution in Example 2.

FIG. 8 is a working curve showing the induction time t of the clock system as a function of the concentration of hydroquinone in Example 2.

FIG. 9 is a graph showing that a pH value in the detection solution (CAT clock reaction system) changes with time when no sample is added into the detection solution in Example 3.

FIG. 10 is a graph showing that a pH value in the detection solution (CAT clock reaction system) changes with time after addition of hydroquinone to make hydroquinone have concentration of 1.33×10⁻⁷ mol/L in the detection solution in Example 3.

FIG. 11 is a graph showing that a pH value of the detection solution (CAT clock reaction system) changes with time after addition of hydroquinone to make hydroquinone have concentration of 4.44×10⁻⁸ mol/L in the detection solution in Example 3.

FIG. 12 is a working curve showing the induction time t of the clock system as a function of the concentration of hydroquinone in Example 3.

### DETAILED DESCRIPTION

### Example 1

Quantitative analysis of hydroquinone was performed by using a “NaClO₂—C₄H₁₃NO—Na₂S₄O₆” CAT clock reaction system as a detection solution. Standard sample solutions with equal volumes but different concentrations of hydroquinone were each added to each of the CAT clock reaction systems, and a working curve (such as a linear relationship) between a concentration of the hydroquinone in the detection system and an induction time t was established. In this way, the concentration of hydroquinone in the CAT clock reaction system was detected, and then the original concentration of the hydroquinone in a sample to be detected was calculated.

### (1) Preparation of a Detection Solution

NaClO₂ solution with a concentration of 0.02 mol/L, C₄H₁₃NO solution with a concentration of 0.0025 mol/L, and Na₂S₄O₆ solution with a concentration of 0.005 mol/L were separately prepared with distilled water as a solvent. 25 mL of the NaClO₂ solution, 5 mL of the C₄H₁₃NO solution, and 15 mL of the Na₂S₄O₆ solution were added in sequence into a 50 mL beaker to obtain a “NaClO₂—C₄H₁₃NO—Na₂S₄O₆” CAT clock reaction system, which contains 0.01111 mol/L NaClO₂, 0.0002778 mol/L C₄H₁₃NO, and 0.001667 mol/L Na₂S₄O₆. The CAT clock reaction system had a total volume of 45 mL and a temperature of 23° C.

A series of standard sample solutions of hydroquinone with different concentrations were prepared by using distilled water as a solvent.

(2) Obtaining Graphs with Each Graph Showing that a pH Value in the Detection Solution (CAT Clock Reaction System) Changes with Time

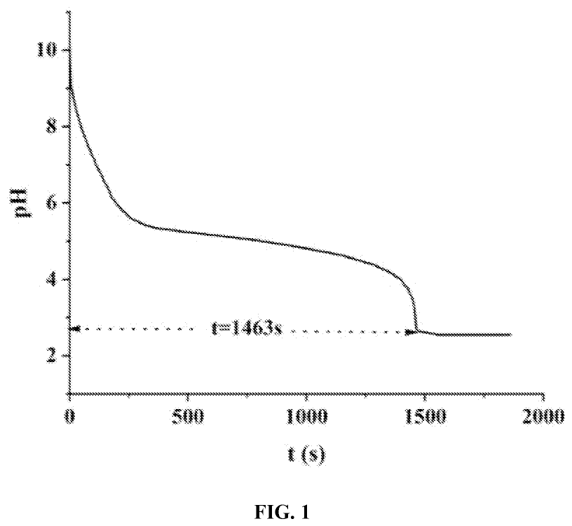

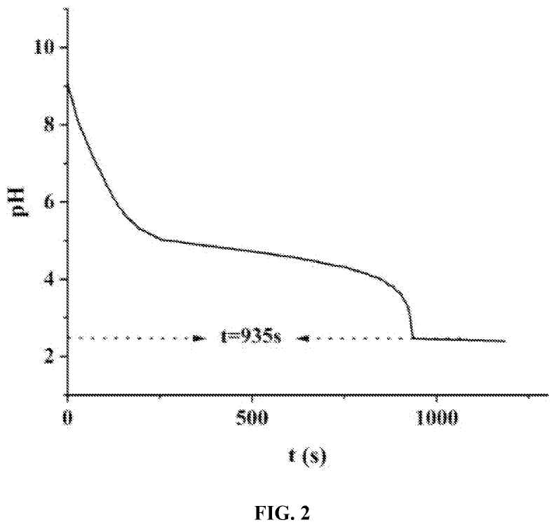

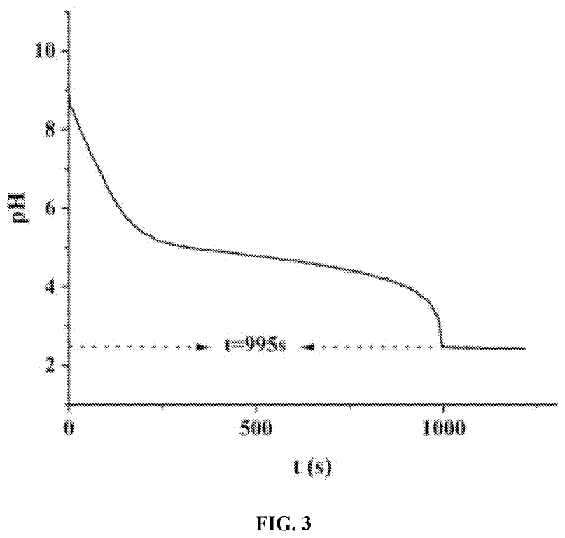

A graph showing that pH value in the detection solution (no sample was added thereto) changes over time was recorded by a computer equipped with a Chemical Signal Acquisition and Analysis program, as shown in FIG. 1. An induction time of 1,463 sec (in FIG. 1) was used as a blank control. Another two sets of detection solutions were prepared with the same concentration of each component as those in the above detection solution. For one set, 20 μL of a hydroquinone sample solution with a concentration of 0.0003 mol/L was added into 45 mL of the CAT clock reaction system upon the clock reaction started, making the concentration of hydroquinone in the detection solution to be 1.33×10⁻⁷ mol/L. The added hydroquinone reduced the induction time to 935 sec, as shown in FIG. 2. For the other set, 20 μL of a hydroquinone sample solution with a concentration of 0.00025 mol/L was added into 45 mL of the CAT clock reaction system upon the clock reaction started, making the concentration of hydroquinone in the detection solution to be 1.11×10⁻⁷ mol/L. The added hydroquinone changed the induction time to 995 sec, as shown in FIG. 3. The facts in FIG. 2 and FIG. 3 show that different concentrations of hydroquinone in the detection solution lead to different induction times for the CAT clock reaction system. When the concentration of hydroquinone in the detection system is in a range of 4.44×10⁻⁸ mol/L to 1.33×10⁻⁷ mol/L, it could be observed that different concentrations lead to different induction times for the CAT clock reaction system.

### (3) Quantitative Detection

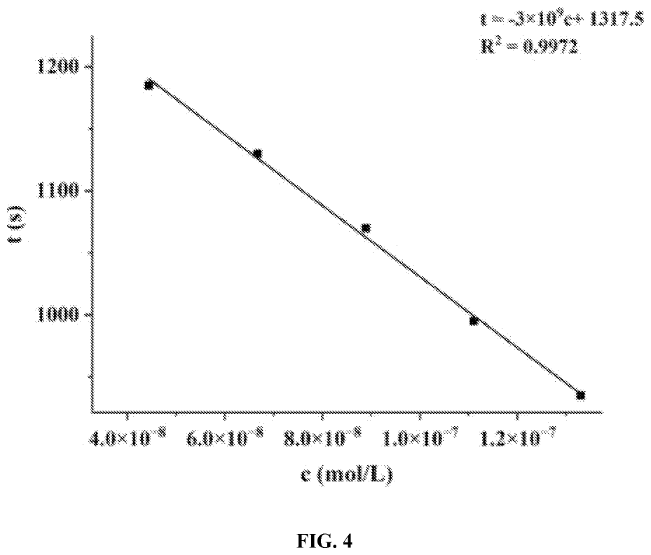

A working curve was established based on a relationship between the concentration of the hydroquinone in the detection system and the induction time, as shown in FIG. 4. In FIG. 4, an abscissa represented the concentration of the hydroquinone in the CAT clock reaction system, and an ordinate represented the induction time t. When the concentration of hydroquinone in the CAT clock reaction system is in a range of 4.44×10⁻⁸ mol/L to 1.33×10⁻⁷ mol/L, there was a linear relationship between the induction time t and the concentration of the hydroquinone in the CAT clock reaction system, and a linear equation was as follows: t=−3×10⁹c+1317.5, R²=0.9972. Based on this, the quantitative detection of hydroquinone in the sample could be achieved.

### Example 2

### (1) Preparation of a Detection Solution

NaClO₂ solution with a concentration of 0.02 mol/L, C₄H₁₃NO solution with a concentration of 0.0025 mol/L, and Na₂S₄O₆ solution with a concentration of 0.005 mol/L were separately prepared with distilled water as a solvent. 24.0 mL of the NaClO₂ solution, 7 mL of the C₄H₁₃NO solution, and 14 mL of the Na₂S₄O₆ solution were added in sequence into a 50 mL beaker to obtain a “NaClO₂—C₄H₁₃NO—Na₂S₄O₆” CAT clock reaction system, which contains 0.01067 mol/L NaClO₂, 0.0003889 mol/L C₄H₁₃NO, and 0.001556 mol/L Na₂S₄O₆. The CAT clock reaction system had a total volume of 45 mL and a temperature of 23° C.

A series of standard sample solutions of hydroquinone with different concentrations were prepared by using distilled water as a solvent.

(2) Obtaining Graphs with Each Graph Showing that a pH Value in the Detection Solution (CAT Clock Reaction System) Changes with Time

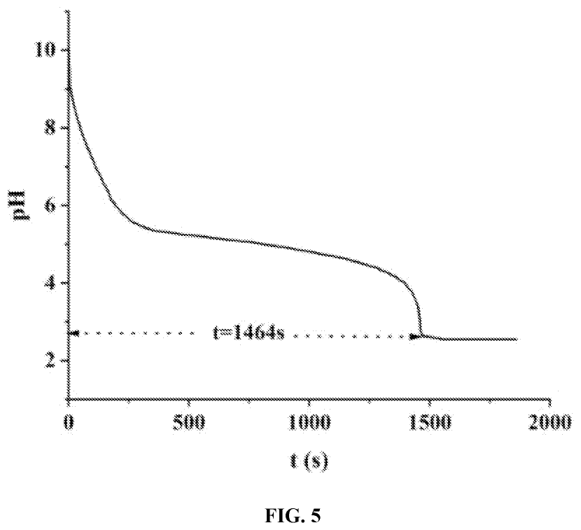

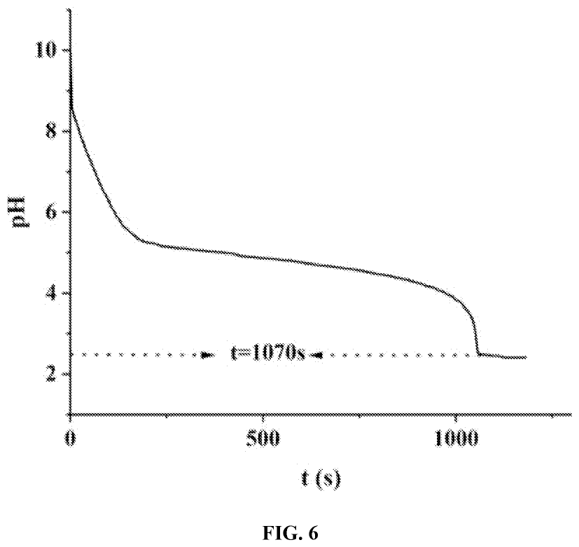

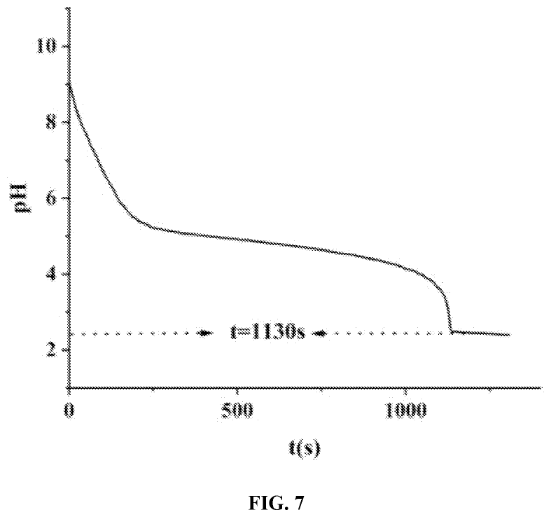

A graph showing that pH value in the detection solution (no sample was added thereto) changes over time was recorded by a computer equipped with a Chemical Signal Acquisition and Analysis program, as shown in FIG. 5. An induction time of 1,464 sec (in FIG. 5) was used as a blank control. Another two sets of detection solutions were prepared with the same concentration of each component as those in the above detection solution. For one set, 20 μL of a hydroquinone sample solution with a concentration of 0.0002 mol/L was added into 45 mL of the CAT clock reaction system upon the clock reaction started, making the concentration of hydroquinone in the detection solution to be 8.89×10⁻⁸ mol/L. The added hydroquinone reduced the induction time to 1,070 sec, as shown in FIG. 6. For the other set, 20 μL of a hydroquinone sample solution with a concentration of 0.00015 mol/L was added into 45 mL of the CAT clock reaction system upon the clock reaction started, making the concentration of hydroquinone in the detection solution to be 6.67×10⁻⁸ mol/L. The added hydroquinone changed the induction time to 1,130 sec, as shown in FIG. 7. The facts in FIG. 6 and FIG. 7 show that different concentrations of hydroquinone in the detection solution lead to different induction times for the CAT clock reaction system. When the concentration of hydroquinone in the detection system is in a range of 4.44×10⁻⁸ mol/L to 1.33×10⁻⁷ mol/L, it could be observed that different concentrations lead to different induction times for the CAT clock reaction system.

### (3) Quantitative Detection

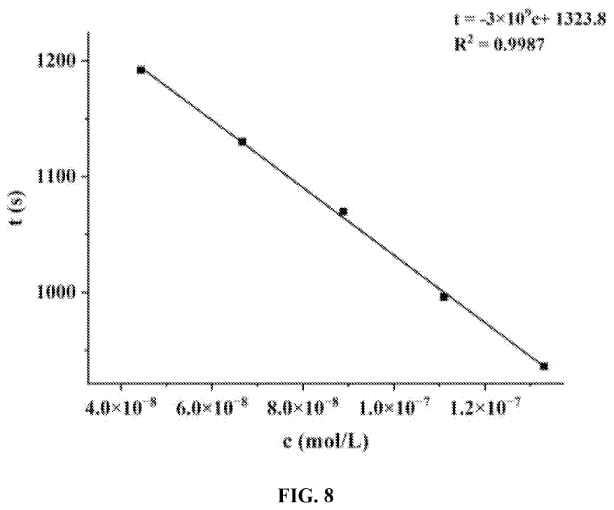

A working curve was established based on a relationship between the concentration of the hydroquinone in the detection system and the induction time, as shown in FIG. 8. In FIG. 8, an abscissa represented the concentration of the hydroquinone in the CAT clock reaction system, and an ordinate represented the induction time t. When the concentration of hydroquinone in the CAT clock reaction system is in a range of 4.44×10⁻⁸ mol/L to 1.33×10⁻⁷ mol/L, there was a linear relationship between the induction time t and the concentration of the hydroquinone in the CAT clock reaction system, and a linear equation was as follows: t=−3×10⁹c+1323.8, R²=0.9987. Based on this, the quantitative detection of hydroquinone in the sample could be achieved.

### Example 3

### (1) Preparation of a Detection Solution

NaClO₂ solution with a concentration of 0.02 mol/L, C₄H₁₃NO solution with a concentration of 0.0025 mol/L, and Na₂S₄O₆ solution with a concentration of 0.005 mol/L were separately prepared with distilled water as a solvent. 26.0 mL of the NaClO₂ solution, 6 mL of the C₄H₁₃NO solution, and 13 mL of the Na₂S₄O₆ solution were added in sequence into a 50 mL beaker to obtain a “NaClO₂—C₄H₁₃NO—Na₂S₄O₆” CAT clock reaction system, which contains 0.01156 mol/L NaClO₂, 0.0003333 mol/L C₄H₁₃NO, and 0.001444 mol/L Na₂S₄O₆. The CAT clock reaction system had a total volume of 45 mL and a temperature of 23° C.

A series of standard sample solutions of hydroquinone with different concentrations were prepared by using distilled water as a solvent.

(2) Obtaining Graphs with Each Graph Showing that a pH Value in the Detection Solution (CAT Clock Reaction System) Changes with Time

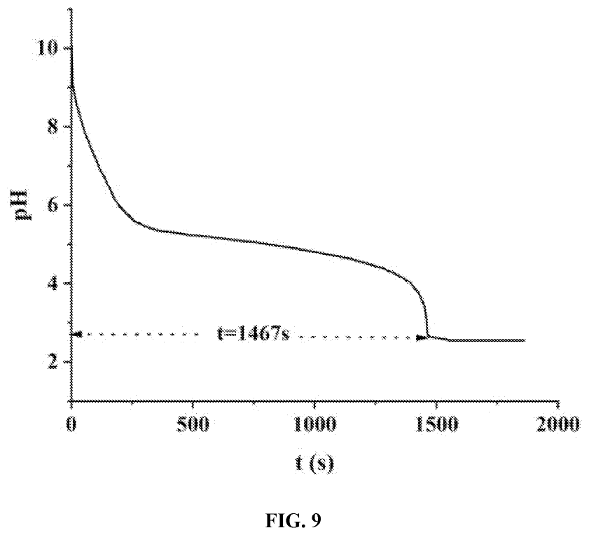

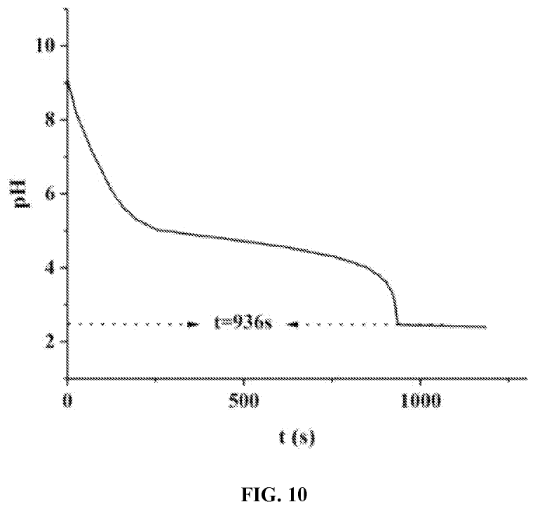

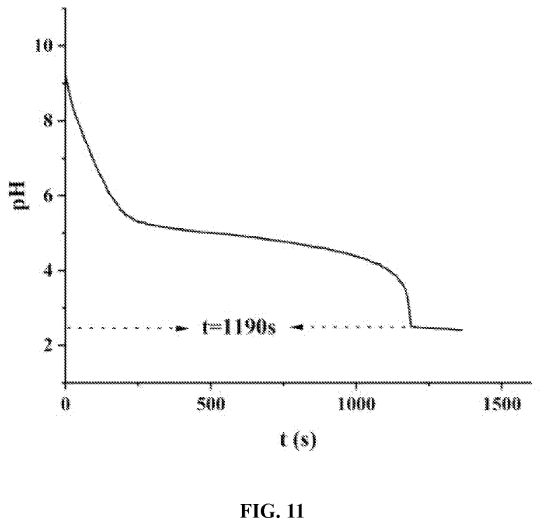

A graph showing that pH value in the detection solution (no sample was added thereto) changes over time was recorded by a computer equipped with a Chemical Signal Acquisition and Analysis program, as shown in FIG. 9. An induction time of 1,467 sec (in FIG. 9) was used as a blank control. Another two sets of detection solutions were prepared with the same concentration of each component as those in the above detection solution. For one set, 20 μL of a hydroquinone sample solution with a concentration of 0.0003 mol/L was added into 45 mL of the CAT clock reaction system upon the clock reaction started, making the concentration of hydroquinone in the detection solution to be 1.33×10⁻⁷ mol/L. The added hydroquinone reduced the induction time to 936 sec, as shown in FIG. 10. For the other set, 20 μL of a hydroquinone sample solution with a concentration of 0.0001 mol/L was added to 45 mL of the CAT clock reaction system up the clock reaction started, making the concentration of hydroquinone in the detection solution to be 4.44×10⁻⁸ mol/L. The added hydroquinone changed the induction time to 1,190 sec, as shown in FIG. 11. The facts in FIG. 10 and FIG. 11 show that different concentrations of hydroquinone in the detection solution lead to different induction times for the CAT clock reaction system. When the concentration of hydroquinone in the detection system is in a range of 4.44×10⁻⁸ mol/L to 1.33×10⁻⁷ mol/L, it could be observed that different concentrations lead to different induction times for the CAT clock reaction system.

### (3) Quantitative Detection

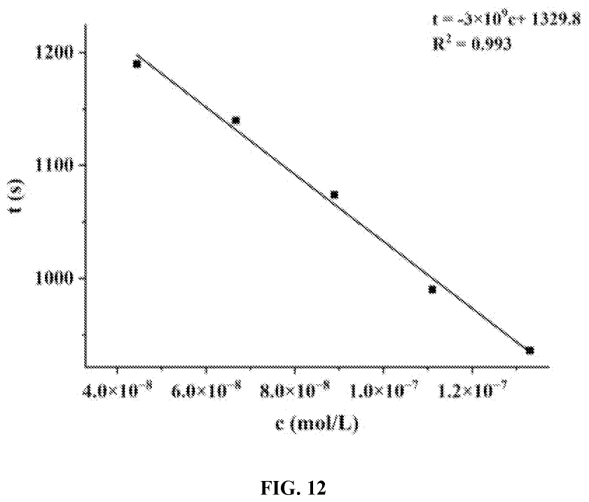

A working curve was established based on a relationship between the concentration of the hydroquinone in the detection system and the induction time, as shown in FIG. 12. In FIG. 12, an abscissa represented the concentration of the hydroquinone in the CAT clock reaction system, and an ordinate represented the induction time t. When the concentration of hydroquinone in the CAT clock reaction system is in a range of 4.44×10⁻⁸ mol/L to 1.33×10⁻⁷ mol/L, there was a linear relationship between the induction time t and the concentration of the hydroquinone in the CAT clock reaction system, and a linear equation was as follows: t=−3×10⁹c+1329.8, R²=0.993. Based on this, the quantitative detection of hydroquinone in the sample could be achieved.

What is claimed is:

1. A method for quantitatively detecting hydroquinone, comprising:
preparing standard sample solutions of hydroquinone by using distilled water as a solvent;
using a “NaClO₂—C₄H₁₃NO—Na₂S₄O₆” CAT clock reaction system as a detection solution, wherein C₄H₁₃NO is tetramethylammonium hydroxide, and the CAT clock reaction system has a temperature of 23° C.±0.5° C., and recording a graph showing that a pH value changes with time;
separately adding the standard sample solutions of hydroquinone with equal volumes but with a series of different concentrations into each of the CAT clock reaction systems when the CAT clock reaction starts, and obtaining the fact that the CAT clock reaction systems show different induction times to added solutions of hydroquinone with different concentrations; and
establishing a working curve based on a relationship between the concentrations of hydroquinone in the CAT clock reaction system and the induction times, wherein an abscissa in the working curve represents the concentrations of hydroquinone in the CAT clock reaction system, and an ordinate in the working curve represents the induction times t; and under the condition that the concentration of hydroquinone in the CAT clock reaction system is a range of 4.44×10⁻⁸ mol/L to 1.33×10⁻⁷ mol/L, there is a linear relationship between the induction times t and the concentrations of hydroquinone in the CAT clock reaction system, thereby achieving a quantitative detection of the hydroquinone in a test sample;
wherein the detection solution comprises NaClO₂ with a concentration of 0.01 mol/L to 0.02 mol/L, C₄H₁₃NO with a concentration of 0.00021 mol/L to 0.0004 mol/L, and Na₂S₄O₆ with a concentration of 0.0012 mol/L to 0.0019 mol/L.

2. The method according to claim 1, wherein in the detection solution, the concentration of NaClO₂ is 0.01067 mol/L, the concentration of C₄H₁₃NO is 0.0003889 mol/L, and the concentration of Na₂S₄O₆ is 0.001556 mol/L.

3. The method according to claim 1, wherein the CAT clock reaction system has the temperature of 23° C.
